(19) United States
(12) Patent Application Publication
(10) Pub. No.: US 2016/0070948 A1
(43) Pub. Date: Mar. 10, 2016

(54) SENSOR SYSTEM AND METHOD FOR RECORDING A HAND VEIN PATTERN

(71) Applicant: Iris-GmbH Infrared & Intelligent Sensors, Berlin (DE)

(72) Inventors: Andreas Thun-Hohenstein, Berlin (DE); Jörg Schenk, Berlin (DE)

(21) Appl. No.: 14/889,888

(22) PCT Filed: May 5, 2014
(86) PCT No.: PCT/EP2014/059058

§ 371 Date: Nov. 9, 2015

(30) Foreign Application Priority Data
May 10, 2013 (DE) 10 2013 208 654.7

(51) Int. Cl. G06K 9/00; G06K 19/07; G06T 7/00; G06T 17/05; H04N 5/33; H04N 9/04

(52) U.S. Cl. CPC G06K 9/00033; H04N 5/33; H04N 9/045; G06T 7/0012; G06T 17/05; G06T 7/0073; G06K 19/0723; G06K 2009/00932; G06T 2207/10152; G06T 2207/30101

(57) ABSTRACT

The invention relates to a sensor system for recording a hand vein pattern. The sensor system comprises a first light source, which is designed to emit, during operation, electromagnetic waves in the near infrared range, which are able to be reflected by veins in a hand, over the entire surface, a camera having a camera chip for recording reflection signals for electromagnetic waves and for delivering image data that correspond to the reflection signals, a topography sensor for sensing three-dimensional topographies and a first processor unit, which is connected to the camera chip and to the topography sensor. The first processor unit is designed to generate from the image data from the camera and the three-dimensional topography data from the topography sensor, during operation, a normalized vein pattern for a hand or a feature vector that corresponds to the vein pattern.

The invention relates to a sensor system for recording a hand vein pattern and a method for recording a hand vein pattern.

Sensors for recording hand vein patterns, whose signals are used for an identification, are known from the prior art.

The problem of the present invention is that of providing an improved sensor system and an improved method for recording hand vein patterns.

This problem is solved according to a first aspect of the invention by a sensor system, which comprises a light source, a camera, a topography sensor and a processor unit. The first light source is designed to emit electromagnetic waves in the near-infrared range over the entire surface, which waves can be reflected by the veins of a hand. The camera comprises a camera chip and is designed and arranged to record reflection signals of electromagnetic waves such that it is capable of receiving radiation reflected by a hand when the sensor system is in operation. The camera is moreover designed to process the recorded reflection signals into corresponding image data. When it is in operation, the topography sensor is designed and arranged in such a way that it records topography data of the hand. The processor unit is connected to the camera chip and the topography sensor and is designed to calculate a normalized vein pattern of the hand from the image data and the topography data.

According to a second aspect, the invention relates to a method for recording a hand vein pattern. The process comprises the steps: irradiating a hand with a first light source that emits electromagnetic waves in the near-infrared range over the entire surface, which waves can be reflected by the veins in a hand; recording reflection signals of the veins; generating corresponding image data from the reflection signals; recording topography data of the hand and generating a normalized vein pattern of the hand or a feature vector corresponding to the vein pattern from the image data and the topography data.

The invention includes the finding that a vein pattern in a normal position can be calculated by combining topography data and the recorded vein pattern, and the vein pattern output by the sensor system is therefore independent of the position and spread of the hand in relation to the sensor system.

According to the invention, the processor unit combines the topography data and the vein pattern in such a way that it is possible to calculate a normalized vein pattern and a normalized hand geometry image, that is, a normalized topography of the hand. Hence, this is a position normalization in space. Hand geometry and vein branching are both spatial structures, the 2-D imaging of which on a camera chip depends on its spatial position (rotation, tilt, curvature, etc.). In this way, a vein detection system can be constructed, which is tolerant with respect to hand position and which does not require any mechanical supports for the hand.

The device according to the invention and the method according to the invention can be used both for vein patterns of the palm and the vein patterns of the back of the hand.

Embodiments of the sensor system according to the invention and the method according to the invention will be described below. The additional features of the embodiments can be combined to create further embodiments, unless the description explicitly describes them as alternatives to each other.

In a preferred embodiment, the sensor system has an additional processor unit that is designed to compare the vein pattern calculated by the first processor unit or the calculated feature vector with at least one stored vein pattern or with at least one stored feature vector, and to classify the calculated vein pattern or the calculated feature vector as sufficiently consistent or not sufficiently consistent. Using the normalized vein pattern, a classification can thus be carried out, regardless of the position and spread of the hand.

An advantageous embodiment of a sensor system is one comprising a second light source, which emits the electromagnetic radiation in the infrared range in the form of a structure image, a second camera chip for recording reflection signals of electromagnetic waves and a calculating unit, which is designed to calculate the recorded reflection data of a topography. The second light source sends a structured light image, for example one having a stripe or dot structure, and projects this light image onto the hand. The reflected structure image is then imaged on the camera chip. The camera chip signal of this image depends both on the structure of the palm (curvature) and on the position of the hand in space (rotation, tilt). By recording with the structured light using the calculating unit, it is possible to identify the position by calculating triangulation equations and to reverse-calculate the structure image to the standard position or to convert it to a feature vector and to provide a comparison at a later time. In the first processor unit, a normalized vein pattern can then be calculated, using the position information thus obtained. The sensor system preferably has a camera chip which functions as both the first and the second camera chip.

In an advantageous embodiment, the first light source and the second light source alternately send electromagnetic waves in immediate succession from image to image or partial images, such that a complete vein image (first light source) and a structure image (second light source) are recorded in immediate succession.

The first processor unit is advantageously designed to calculate, in an idle mode of the sensor system in which only the second light source emits electromagnetic waves at regular time intervals of, e.g., 1 to 2 seconds, a distance from the reflection signal, and to start an irradiation with the first light source if it falls below a predetermined minimum distance. This allows for an efficient operation of the system, since the irradiation with the first light source and calculations are carried out only when an object is located in the irradiated area.

In an alternative embodiment, the topography sensor is a time-of-flight sensor. It determines the distance of an object from the sensor for each pixel by capturing the return time of the infrared light pulse and by calculating the distance using the speed of light.

It is advantageous if the additional processor unit is an RFID (radio frequency identification) host processor and the comparison takes place with a vein pattern or feature vector stored in an RFID slave processor. In this case, a classification is only possible if a connecting channel has been established between the RFID host processor and an RFID slave processor. This allows an identification without storing data in a database system and thus ensures greater security, since both the valid vein pattern and the RFID slave processor must exist in the sensor system for an identification.

Alternatively, another type of connection processor, which realizes at least one active wireless connection capability, preferably according to the known standards WLAN, Bluetooth, ZigBee or NFC, may take the place of the RFID host processor. In this case, the slave processor is also equipped with at least the same active wireless connection capability as the host processor. As described with regard to RFID, the comparison takes place with a vein pattern or feature vector stored in the slave processor.

The comparison with vein patterns or feature vectors that are stored in a database is however also of advantage. In this case, not every user must be equipped with an additional identification element; rather, the user can make the classification on the basis of the already existing pattern.

One advantageous embodiment has a release unit that is associated with the sensor system, which makes it possible to give access to a downstream system with a vein pattern or feature vector classified as sufficiently consistent, for example to a banking system or other input system. But access rights, for example to buildings or public transport facilities, can also be advantageously issued by the release unit.

A further development of the invention relates to a bracelet with an integrated slave processor, in which the slave processor contains information about a stored vein pattern or a stored feature vector and is able to communicate with a host processor of the sensor system described.

In one embodiment, the slave processor is an integrated RFID slave processor, in which the RFID slave processor contains information about a stored vein pattern or a stored feature vector and is able to communicate with an RFID host processor of the sensor system described.

An alternative to the aforementioned bracelet with integrated RFID slave processor may also be a bracelet with an active slave processor, in other words, an actively powered processor which has a stored vein pattern or a feature vector and an active wireless connection capability, preferably according to one of the known standards WLAN, Bluetooth, ZigBee or NFC. Here, the active slave processor is designed in such a way that the stored vein pattern or the stored feature vector cannot be read without permission; preferably a TEE (Trusted Execution Environment) may be used for the purpose.

As an alternative, so-called smart watches or smart bracelets could be used (smart watch; smart wristband, wearable wristband, etc.). Smart watches or bracelets are referred to as wrist-wearable computers, which have short-distance wireless connection capabilities and can transmit specific messages to their users.

The user, who at the same time is the wearer of this smart bracelet, is permitted access to the desired system without having to reveal his person. This aspect is essential from a data protection point of view.

If the user approaches an access point containing the sensor system and places his hand, on which he also wears the bracelet, in front of the sensor system, the sensor is activated. The RFID host processor or the active host processor sends the calculated vein pattern or the feature vector to the bracelet via the established RF channel or wireless channel. This is followed by the identification mechanism already described.

In such a system application, the bracelet may be used, for example, as a bank card, a monthly pass for local travel, a ticket for long-distance travel, a boarding pass for air travel or as an identification for access authorization.

It is a particular advantage of the described bracelet that even the loss of a smart bracelet does not create the potential for abuse. The bracelet can only be used in conjunction with the hand vein pattern. But because personally identifying data is not stored on the bracelet, a lost bracelet is worthless.

The slave processor, in particular the RFID slave processor or the active slave processor, may also contain an additional code, which can only be read or sent as sufficiently consistent after a calculated vein pattern or feature vector has been identified.

In a further development of the invention, the sensor system is installed via a keyboard. Here, a vein pattern on the back of the hand is detected, which makes simple identification possible, even during an input operation. The second processor unit of the sensor system is configured and connected to the keyboard in such a way that, whenever a key is pressed, a verification process of the vein pattern can simultaneously be triggered. Entering the character or a group of characters will only be recognized as valid if the vein verification is detected as sufficiently consistent. The advantage of such an arrangement is that a permanent authentication of the user in a communication process, for example with a computer, can be guaranteed.

Equally advantageously, the sensor system may also be integrated in a keyboard and utilize a vein pattern of the palm for identification. Here, the keyboard is designed such that the heels of the hand always hover above the part of the keyboard facing the user, or they may even rest on it, while the fingers can reach the keys. A deliberately narrow arrangement of the keys is thus selected. Number keys or other function keys are arranged either to the right or left of the letter keys. In the part of the keyboard facing the user, a sensor system according to the invention can be integrated either for the left or the right hand. The sensor system is preferably designed in such a way that it can detect the vein structure from a very short distance to the palm; it is capable of capturing the palm having an area of up to 120 mm at a distance from the sensor surface of 5 mm to 20 mm. In one embodiment, the sensor system comprises a plurality of first infrared light sources that are embedded in the computer keyboard in such a way that each first IR light source illuminates the entire surface of a section of the palm. This embodiment moreover comprises a plurality of camera chips, and the reflection signals of the respective sections of the palm, that is, sections of the hand vein pattern, are thus imaged on each of the camera chips. The arrangement of the camera chips and the IR light sources is selected such that the combination of all images of the camera chips creates a substantially complete image of the palm. This complete image is then supplied to a processing course in order to determine the vein pattern template. The arrangement of a plurality of camera chips results from the necessity of the very short object-image distance. When only one camera chip is used, it may potentially happen that the palm cannot be optically recorded in its entirety, and a complete image of the vein pattern can therefore not be made available for processing.

Further embodiments of the method according to the invention and the device according to the invention will be explained below by means of the figures. They show:

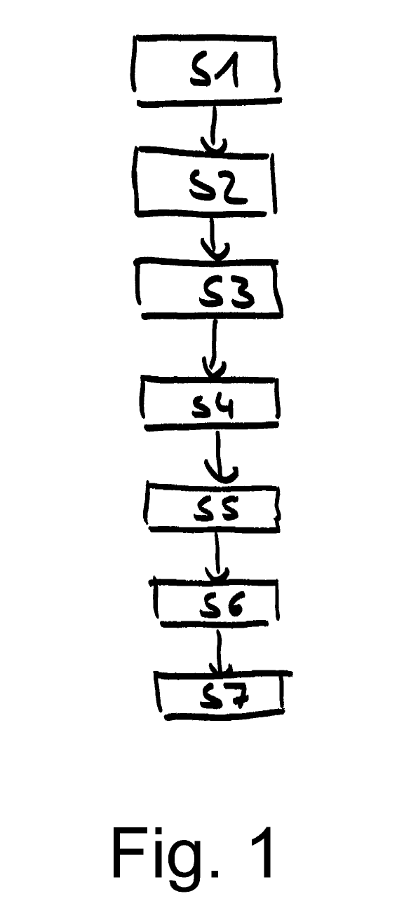

FIG. 1 a flow diagram for an embodiment of the method according to the invention;

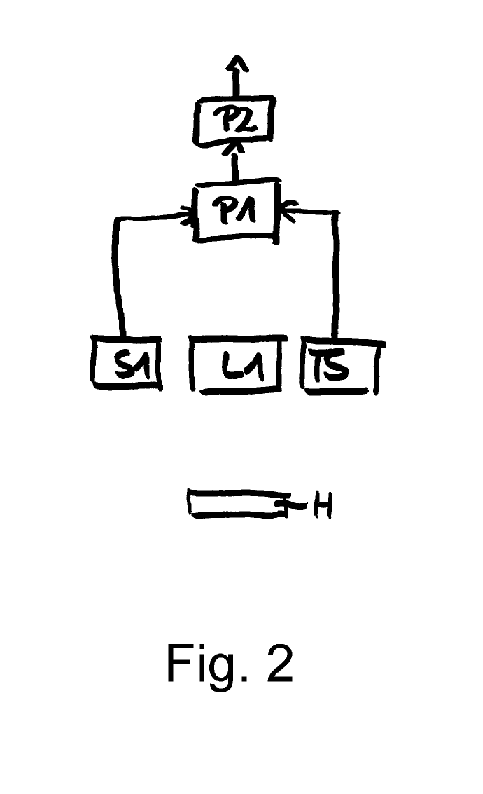

FIG. 2 a schematic representation of an embodiment of a sensor system according to the invention for recording a hand vein pattern;

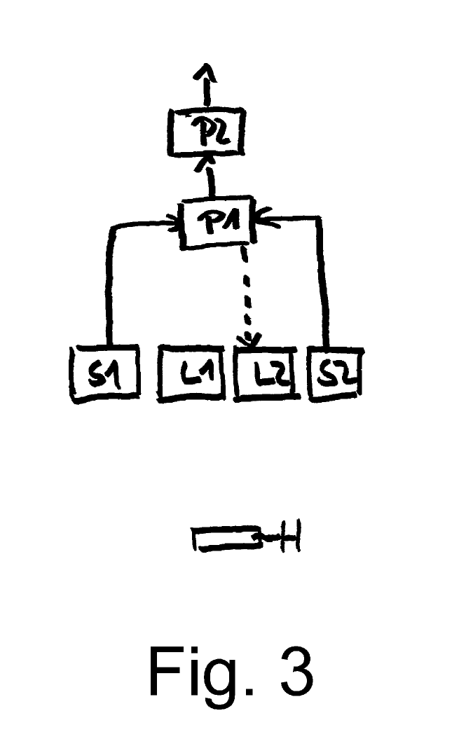

FIG. 3 a schematic representation of another embodiment of a sensor system according to the invention.

FIG. 1 shows a flow diagram of a method for recording a hand vein pattern. In step S1, a hand is irradiated with a first light source that emits electromagnetic waves in the near-infrared range over the entire surface, which waves can be reflected from veins in a hand. In step S2, the reflection signals originating from the veins of the hand are imaged by means of a camera chip, and image data is generated according to the reflection signals. In step S3, the hand is irradiated with a second light source that emits electromagnetic radiation in the infrared range in the form of a structure image, and in step S4, the reflection signals of this irradiation are recorded, and topography data are generates from these reflection signals. In a preferred embodiment, step S3 takes place immediately after step S1, resulting in an immediate succession of image to image or partial images and the hand being in the same position for both irradiations. In step S5, a normalized vein pattern or a feature vector corresponding to the vein pattern is calculated from the topography data obtained and the image data corresponding to the reflection signals from the hand veins. In step S6 in this embodiment, the calculated normalized vein pattern or the calculated feature vector is compared with at least one stored vein pattern or feature vector and subsequently classified as sufficiently consistent or not sufficiently consistent. With this classification, a decision with respect to the release for further processes can now be made in a subsequent further step in an embodiment of the method according to the invention. In step S7, the release for further processing is granted if the vein pattern or the feature vector has been classified as sufficiently consistent.

FIG. 2 shows an embodiment of a sensor system according to the invention for recording a hand vein pattern. The sensor system comprises a first light source L1, a camera S1, a topography sensor TS and a processor unit P1, which is connected to the camera chip and the topography sensor. In a preferred embodiment of the sensor system according to the invention, it also comprises a second processor unit P2. When it is in operation, the first light source L1 is designed to emit electromagnetic waves in the near-infrared range over the entire surface, which waves can be reflected by the veins of a hand H. The camera S1 with a camera chip is used to record reflection signals of electromagnetic waves and supplies corresponding image data to the reflection signals. In the embodiment shown, the camera records the reflection signals that were emitted by the veins of the hand H, and provides corresponding image data. The topography sensor TS is used to capture three-dimensional topographies; it captures the position and the curvature of the hand H. The first processor unit P1 is connected to the camera chip of the camera S1 and the topography sensor TS. From the topography data provided by the topography sensor and the image data of the camera, the processor unit P1 generates a normalized vein pattern or a corresponding feature vector of the hand H irradiated with the light source L1. In a preferred embodiment of the sensor system according to the invention, the additional processor unit P2 serves to compare the vein pattern calculated by the first processor unit P1 or the calculated feature vector with a stored vein pattern or a stored feature vector and to classify the calculated vein pattern or the calculated feature vector as sufficiently consistent or not sufficiently consistently. In a further embodiment of the sensor system according to the invention, a release unit is connected to the sensor system, which is capable of permitting access to a downstream system with a vein pattern classified as sufficiently consistent. The release unit is not shown in FIG. 2.

FIG. 3 shows a schematic representation of another embodiment of a sensor system according to the invention. The basic structure of the sensor system in FIG. 3 is the same as that of the system shown in FIG. 2; only the differences will therefore be described in more detail below. In FIG. 3, the topography sensor consists of a second light source L2 and a sensor S2, which comprises a second camera chip and a calculating unit. The second light source L2 emits electromagnetic radiation in the infrared range in the form of a structure image. The camera chip of the sensor S2 is suitable for recording the reflection signals of electromagnetic waves, and the calculating unit calculates a topography of the object irradiated by the light source L2, here, the hand H, from the recorded reflection signals. As in the method according to FIG. 2, these topography data are sent on to the processor unit P1, and a normalized vein pattern of a hand is generated from the topography data and the image data of the sensor S1. In one embodiment of the sensor system shown, the processor unit P1 can additionally be designed to calculate a distance from the reflection signals in an idle mode of the sensor system, in which only the second light source L2 emits electromagnetic waves at regular intervals, and, when it falls below a predetermined minimum distance, to begin an irradiation with the first light source L1. Particularly advantageous is an embodiment of the sensor system according to the invention, in which the first light source and the second light source are designed in such a way that they alternately emit electromagnetic waves in immediate succession from image to image. It is thus possible to prevent a change in the position or curvature of the hand between the irradiation with the first light source and the irradiation with the second light source, which would lead to distorted vein patterns.

What is claimed is:

1. A sensor system for recording a hand vein pattern, comprising:
a first light source, designed to emit electromagnetic waves in the near-infrared range over the entire surface, which waves can be reflected by the veins of a hand H,
a camera, having a camera chip for recording reflection signals of electromagnetic waves and for providing corresponding image data from the reflection signals,
a topography sensor for capturing three-dimensional topographies and
a first processor unit connected to the camera chip and the topography sensor, characterized in that, when the sensor system is in operation, the first processor unit is configured to generate a normalized vein pattern of a hand or a feature vector corresponding to the vein pattern from the image data of the camera and the three-dimensional topography data of the topography sensor.

2. The sensor system according to claim 1, having an additional processor unit that is designed to compare the vein pattern or the feature vector calculated by the first processor unit with at least one stored vein pattern or with at least one stored feature vector, and to classify the calculated vein pattern or the calculated feature vector as sufficiently consistent or not sufficiently consistent.

3. The sensor system according to claim 1, characterized in that the topography sensor comprises:
a second light source, which emits electromagnetic radiation in the infrared range in the form of a structure image,
a second camera chip for recording reflection signals of electromagnetic waves, and
a calculating unit, which is configured to calculate a topography from the recorded reflection data.

4. The sensor system according to claim 3, characterized in that the first and the second camera chip are identical.

5. The sensor system according to claim 3, characterized in that the first light source and the second light source are configured to alternately emit electromagnetic waves in immediate succession from image to image or partial images.

6. The sensor system according to claim 1, characterized in that the first processor unit is configured to calculate a distance from the reflection signals in an idle mode of the sensor system, in which only the second light source emits electromagnetic waves at regular intervals, and, when the sensor system falls below a predetermined minimum distance, to begin an irradiation with the first light source.

7. The sensor system according to claim 1, characterized in that the topography sensor is a time-of-flight sensor.

8. The sensor system according to claim 2, characterized in that the additional processor unit is a host processor, in particular an RFID host processor or an active host processor with an active wireless connection capability, and is configured in such a way that, when it is in operation, the comparison with a vein pattern or feature vector stored in a slave processor having the same wireless connectivity as the host processor takes place.

9. The sensor system according to claim 2, characterized in that the sensor system is configured in such a way that, when it is in operation, the comparison with vein patterns or feature vectors stored in a database takes place.

10. The sensor system according to claim 2, characterized in that a release unit connected to the sensor system is provided, which is configured to permit access to a downstream system with a vein pattern or feature vector that is classified as sufficiently consistent.

11. A bracelet with an integrated slave processor, in particular with an RFID slave processor or an active slave processor, characterized in that the RFID slave processor contains information about a stored vein pattern or a stored feature vector and is capable of communicating with an RFID host processor of a system according to claim 8.

12. The bracelet according to claim 11, characterized in that the RFID slave processor includes an additional code, which can only be read as sufficiently consistent or be sent after a calculated vein pattern or feature vector has been identified.

13. A method for recording a hand vein pattern, comprising:
irradiating a hand with a first light source that emits electromagnetic waves in the near-infrared range over the entire surface, which waves can be reflected by the veins in a hand,
recording reflection signals from the veins and generating corresponding image data from the reflection signals,
recording topography data of the hand,
calculating a normalized vein pattern of a hand or a feature vector corresponding to the vein pattern from the image data and the topography data.

14. The method according to claim 13, characterized in that a comparison of the calculated normalized vein pattern or the calculated feature vector is carried out with at least one stored vein pattern or feature vector, and the calculated vein pattern or the calculated feature vector is classified as sufficiently consistent or not sufficiently consistent.

15. The method according to claim 14, characterized in that further processes are released after a vein pattern or a feature vector has been identified as sufficiently consistent.

16. The method according to claim 13, characterized in that the recording of topography data comprises:
irradiating the hand with a second light source that emits electromagnetic radiation in the infrared range in the form of a structure image,
recording reflection signals
and generating the topography data from the recorded reflection signals.

17. The sensor system according to claim 2, characterized in that the topography sensor comprises:
a second light source, which emits electromagnetic radiation in the infrared range in the form of a structure image,
a second camera chip for recording reflection signals of electromagnetic waves, and
a calculating unit, which is configured to calculate a topography from the recorded reflection data.

18. The sensor system according to claim 17, characterized in that the first and the second camera chip are identical.

19. The sensor system according to claim 4, characterized in that the first light source and the second light source are configured to alternately emit electromagnetic waves in immediate succession from image to image or partial images.
